(19) United States
(12) Patent Application Publication
(10) Pub. No.: US 2017/0138288 A1
(43) Pub. Date: May 18, 2017

(54) SYSTEM FOR MONITORING INTERNAL PRESSURE OF ENGINE COMBUSTION CHAMBERS

(71) Applicant: GENERAL ELECTRIC COMPANY, Schenectady, NY (US)

(72) Inventors: Pekka Tapani Sipilä, Munich (DE); Jassin Marcel Frtiz, Munich (DE); Johann Hirzinger-Unterrainer, Jenbach (AT); Robert Oliver Dean, Munich (DE)

(21) Appl. No.: 14/940,966

(22) Filed: Nov. 13, 2015

(51) Int. Cl. F02D 41/14; F02D 35/02; F02B 77/08

(52) U.S. Cl. CPC F02D 41/1439; F02B 77/085; F02D 41/1486; F02D 35/023

(57) ABSTRACT

In accordance with one embodiment, an engine includes: a combustion chamber housing surrounding a combustion chamber; a magnetostrictive sensor positioned outside of the combustion chamber and configured for obtaining a sensor signal representative of pressure within the combustion chamber; and a controller for receiving the sensor signal from the sensor, using the sensor signal for estimating the pressure within the combustion chamber, and determining whether to adjust engine operating parameters of the engine in response thereto.

### BACKGROUND

The subject matter disclosed herein relates generally to engines and more particularly to systems for sensing pressure in combustion chambers of engines.

Pressure within combustion chambers of various types of engines impacts operation of such engines. For example, gas engines typically include a plurality of combustion chambers in which an air and fuel mixture is ignited to generate hot combustion gases. Engines operate in many different operating conditions, and combustor performance facilitates engine operation over a wide range of engine operating conditions. Knowledge of the internal pressures of the combustion chambers enables condition monitoring and fault detection of the combustion chambers and is useful when controlling ignition for efficiency and optimal operation of the engine.

The environment within combustion chambers is harsh, which limits the types of pressure sensors that can be used. Known pressure sensors that utilize piezo-electric and piezo-resistive elements have limited life within such environments or require cooling, which increases the material and assembly costs for such engines.

It would be desirable to have a robust, cost-effective pressure sensor for engine monitoring and control.

### BRIEF DESCRIPTION

In accordance with one embodiment of the present disclosure, an engine comprises: a combustion chamber housing surrounding a combustion chamber; a magnetostrictive sensor positioned outside of the combustion chamber and configured for obtaining a sensor signal representative of pressure within the combustion chamber; and a controller for receiving the sensor signal from the sensor, using the sensor signal for estimating the pressure within the combustion chamber, and determining whether to adjust engine operating parameters of the engine in response thereto.

In accordance with another embodiment of the present disclosure, a combustion cylinder comprises a combustion cylinder wall extending along a length of a combustion chamber; a combustion cylinder cover; and a magnetostrictive sensor positioned within a cavity of the combustion chamber or the combustion cover wall and configured for obtaining a sensor signal representative of pressure within the combustion chamber.

### DRAWINGS

These and other features, aspects, and advantages of the present disclosure will become better understood when the following detailed description is read with reference to the accompanying drawings in which like characters represent like parts throughout the drawings, wherein:

FIG. 1 is a block diagram of a known gas engine.

FIG. 2 is a sectional side view of a combustion chamber including one or more sensor apparatus in accordance with one embodiment of the present disclosure.

FIG. 3 is a sectional side view of a sensor apparatus in accordance with one embodiment of the present disclosure.

FIG. 4 is a perspective view of a magnetorestrictive sensor in accordance with one embodiment of the present disclosure.

FIG. 5 is a block diagram of several control options in accordance with embodiments of the present disclosure.

FIG. 6 is a sectional side view of a magnetorestrictive sensor in accordance with another embodiment of the present disclosure.

FIG. 7 is a sectional side view of a sensor apparatus in accordance with another embodiment of the present disclosure.

FIG. 8 is a sectional side view of a magnetorestrictive sensor in accordance another embodiment of the present disclosure.

### DETAILED DESCRIPTION

Unless defined otherwise, technical and scientific terms used herein have the same meaning as is commonly understood by one of skill in the art to which this disclosure belongs. The terms “a” and “an” do not denote a limitation of quantity, but rather denote the presence of at least one of the referenced item, and the term “or” is meant to encompass either any or all of the referenced elements. If ranges are disclosed, the endpoints of all ranges directed to the same component or property are inclusive and independently combinable. Additionally, references to “combustion” are to be understood to refer to a chemical process wherein oxygen, e.g., air, combines with the combustible elements of fuel, namely carbon, hydrogen, and sulfur, at an elevated temperature sufficient to ignite the constituents. Furthermore, the terms “controller,” and “processor” may include either a single component or a plurality of components, which are active and/or passive and are connected or otherwise coupled together to provide the described function. When controller and/or processing functions are embodied in a computer, the computer executes non-transitory code or instructions stored in or accessed from a machine-readable medium (such as a memory unit) to implement the techniques disclosed herein.

Embodiments of the present disclosure are generally directed to a system for generating a signal representative of pressure in harsh environments, such as in the combustion chamber of a reciprocating gas engine. The disclosure is likewise applicable in many different types of combustion devices and may be applied to systems consuming natural gas, fuel, coal, oil or any solid, liquid or gaseous fuel and to combustion chambers that have various shapes.

More specifically, embodiments of the present disclosure use magnetostriction techniques to measure mechanical stress and in turn obtain an indirect estimation of internal pressure of a combustion chamber. Magnetostriction based (sometimes alternatively referred to as magnetoelastic based) methods to measure strain can be made robust for industrial applications and have certain benefits over conventional electrical or optical strain gauges due the fact that mechanical contact is not required. “Magnetostriction,” as used herein, means reorientation of magnetic domains in ferromagnetic materials due to strain.

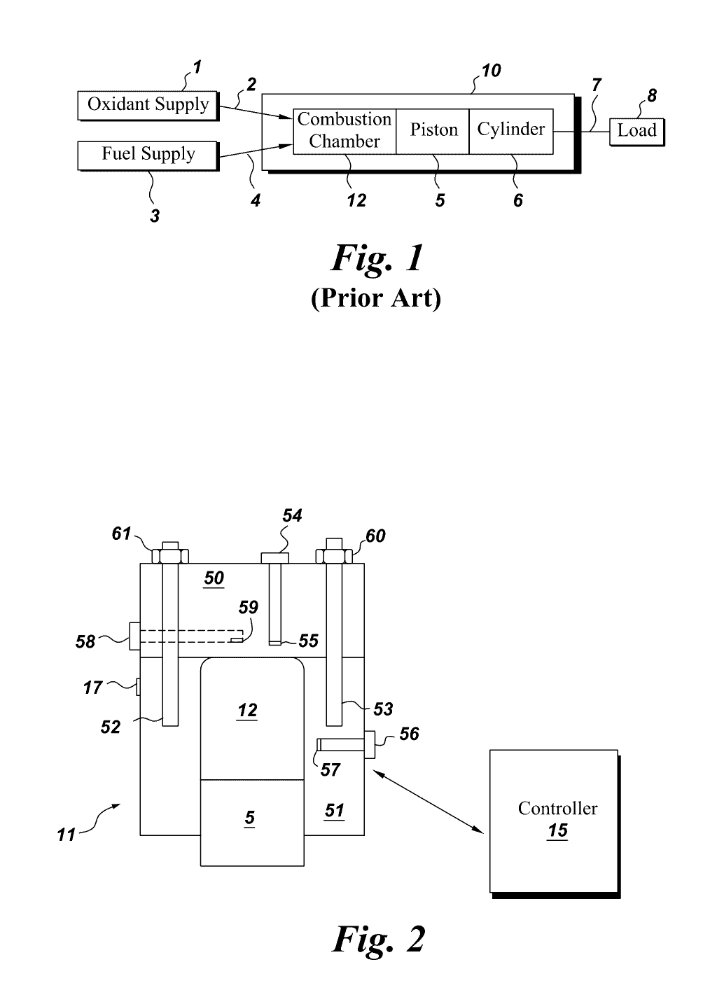

Turning to the drawings, FIG. 1 illustrates a block diagram of an embodiment of a portion of a known gas engine driven power generation system having a reciprocating internal combustion engine. The system includes an engine 10 having one or more combustion chambers 12. An oxidant supply 1 is configured to provide a pressurized oxidant 2, such as air, oxygen, oxygen-enriched air, oxygen-reduced air, or any combination thereof, to each combustion chamber 12. The combustion chamber 12 is also configured to receive a fuel 4 which may comprise any suitable gaseous fuel, such as natural gas, associated petroleum gas, propane, biogas, sewage gas, landfill gas, or coal mine gas, for example, and may also include a variety of liquid fuels, such as gasoline or diesel fuel from a fuel supply 3. A fuel-air mixture ignites and combusts within each combustion chamber 12. The hot pressurized combustion gases cause a piston 5 adjacent to each combustion chamber 12 to move linearly within a pressure conversion chamber 6 and convert pressure exerted by the gases into a rotating motion, which causes a shaft 7 to rotate. Further, shaft 7 may be coupled to a load 8, which is powered via rotation of shaft 7. For example, load 8 may comprise any suitable device that may generate power via the rotational output of the engine 10, such as an electrical generator.

The system may be adapted for use in stationary applications (such as in industrial power generating engines) or in mobile applications (such as in automobile or aircraft engines). The engine 10 may comprise a multi-stroke engine and any number of combustion chambers 12, pistons 5, and associated cylinders 6. For example, in certain embodiments, the engine 10 may include a large-scale industrial reciprocating engine having 4, 6, 8, 10, 16, 24 or more pistons 5 reciprocating in pressure conversion chambers 6. In some such cases, the pistons 5 may have a diameter of between about 13.5 centimeters (cm) to about 34 centimeters. In certain embodiments, combustion chamber walls, covers, and any coupling bolts may comprise various types of steels capable of withstanding combustion conditions. The engine may generate power ranging from about 10 kilowatts to about 10 megawatts. Exemplary engines 10 may include General Electric Company's Jenbacher and Waukesha Engines.

In one embodiment of the present disclosure, as illustrated in FIG. 2, an engine includes a combustion chamber 12, one or more sensor apparatuses 54, 56, 58 including respective magnetostrictive sensors 55, 57, 59, each positioned and configured for obtaining a sensor signal representative of pressure within combustion chamber 12, and a controller 15 for receiving the sensor signal from magnetostrictive sensor 55, 57 and/or 59, using the sensor signal for estimating the chamber pressure, and determining whether to adjust engine operating parameters of the engine 10 in response thereto. Although three magnetostrictive sensors 55, 57, and 59 are shown for purposes of example in FIG. 2, in some embodiments, a single magnetostrictive sensor may be used or a different number of magnetostrictive sensors may be used. Examples of operating parameters that may be adjusted in response to pressure information include fuel injection timing and amount, ignition timing, manifold pressure set point, and exhaust gas recirculation.

In the embodiment of FIG. 2, a combustion chamber cover 50 is secured by bolts 52, 53 and nuts 60, 61 to at least one combustion chamber wall 51 of a combustion chamber housing 11. In embodiments described herein, the combustion chamber is primarily described as cylindrically shaped for purposes of illustration such that there is a single wall; however, other shapes may be used if desired and multiple walls may be present. FIG. 2 illustrates, more specifically, a minimally intrusive embodiment wherein magnetostrictive sensors are shown as being integrated within combustion chamber cover 50 (sensors 55 and 59) or within combustion chamber wall 51 (sensor 57) and facing combustion chamber 12. In each of these embodiments there is a cycle changing of elongation or force on the respective magnetostrictive sensor. For increased resolution, it is useful to position the sensor or sensors 55, 57, 59 as close to and facing either combustion chamber 12 or the interface between combustion chamber cover 50 and combustion chamber wall 51.

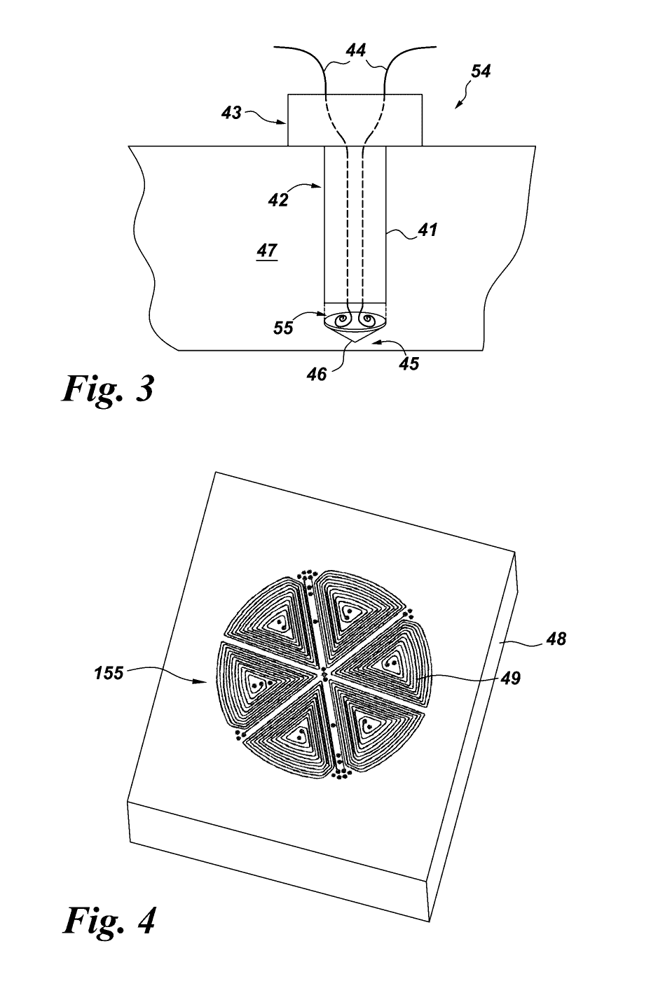

FIG. 3 is a sectional side view of a more specific embodiment of sensor apparatus 54 for purposes of example. In the embodiment of FIG. 3, a cavity 41 is provided in a substrate 47 which may comprise the combustion chamber wall 51 or cover 50 (FIG. 2), for example. Cavity 41 may be threaded or non-threaded and is sized to allow a shaft 42 of sensor apparatus 54 to be inserted therein. A head 43 of sensor apparatus 54 may be integral to or coupled to shaft 42. Shaft 42 and head 43 may comprise any suitable material with several examples including high temperature resistant metal materials such as steel and aluminum and thermoplastic materials such as polyether ether ketone and may be coupled to substrate 47 via threading, adhesion, or welding, for example. If present, wires 44, which comprise insulated wires in embodiments comprising a conductive head or shaft, may extend from magnetostrictive sensor 55 to controller 15.

Magnetostrictive sensor 55 is positioned as close as reasonable to a high mechanical load region 45 for optimal resolution while keeping enough thickness in the region so as not to compromise structural integrity. In some embodiments, a tapered gap 46 may be present at the end of cavity 41 if desired to provide a higher load region with a smaller diameter than that of the main shaft. In one example, the diameter of shaft 42 is on the order of one or two centimeters, and the distance of the narrowest portion of the substrate in the high mechanical load region 45 is on the order of several tens of millimeters.

Sensor apparatus 54 was shown in FIG. 3 for purposes of example. Sensor apparatus 56 may comprise a similar embodiment as that of sensor apparatus 54, if desired, in that it would typically have the magnetostrictive sensor oriented at the end of the shaft 42. In contrast sensor apparatus 58 would typically be adjusted so that the magnetostrictive sensor would be oriented on a side of shaft 42 facing the combustion chamber 12 (as shown in FIG. 2).

FIG. 4 is a perspective view of a magnetorestrictive sensor 155 comprising an alternative current (AC) magnetostrictive sensor in accordance with one embodiment of the present disclosure. In this embodiment a plurality of coils 49 are positioned on a support structure 48. Support structure 48 may comprise a material such as a glass epoxy, a polyimide, polyether ether ketone, or other thermoplastic, for example. In a more specific embodiment, support structure 48 comprises a printed circuit board with coils 49 embedded thereon. Coil materials may comprise copper, aluminum, brass, iron, or combinations thereof, for example. If desired ferrite slabs (not shown) or cores may be positioned relative to coils 49.

Multiple coils 49 of the type shown in FIG. 4 may be used to measure magnetic fields in different angles. In the specific example of FIG. 4, three pairs of coils are used to measure magnetic fields at one hundred twenty degree angular intervals. Such embodiments are useful in enabling controller 15 (FIG. 2) to resolve stress orientations and be more reliable regardless of which angular orientation shaft 42 ends up in during the installation. If desired, multiple layers of coils (not shown) may be used to further increase reliability.

With reference to FIGS. 3 and 4, if there is any variance between magnetorestrictive sensor 155 and the end of cavity 41 where the sensor is inserted into, signal phase and amplitude of the measured signals may be processed to compensate for such variance. As one example, compensation for variations in the proximity of the sensor to the load region 45 may be achieved by measuring not only the amplitude but also the phase of the signals coupled to the sensing coils 49. Due to different electromagnetic properties of the coils and air (or any non-conductive, non-magnetic material), changes in the signal response due to load changes vary fundamentally from proximity changes in the phase-amplitude plane. This fact may be exploited in the signal processing of controller 15 for ensuring accurate load measurements also at the presence of non-constant proximity to the load region.

For AC coil type magnetostrictive sensors, an excitation signal is sent through a coil, and a sensor signal is then detected either with the same coil or an additional coil. As the pressure changes in the combustion cylinder, the permeability of the material in the wall or cover of the combustion cylinder changes such that the electromagnetic properties sensed by the magnetostrictive sensor will be proportional to the pressure.

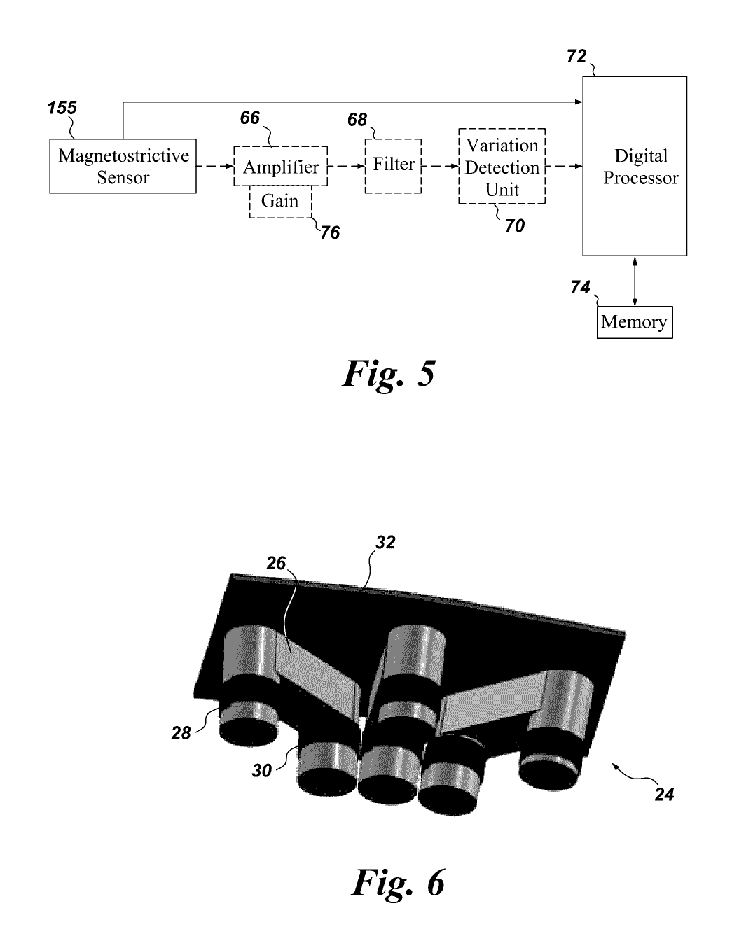

In one embodiment, as shown in FIG. 5, the sensor signal from magnetostrictive sensor 155 may be transmitted through one or more analog or digital processing elements such as an amplifier 66, a filter 68, and a variation detection circuit 70 such as a down-conversion unit or a peak detection unit prior to being provided to a digital processor 72 of controller 15 (FIG. 2). In another embodiment, the sensor signal from magnetostrictive sensor 14 is provided directly to digital processor 72 which may optionally include digital processing functions of amplification, filtering, and variation detection. In either embodiment, digital processor 72 executes non-transitory code or instructions stored in or accessed from a machine-readable medium such as a memory 74.

In one embodiment, information is obtained regarding the magnetic field at zero pressure and regarding the magnetic field at one or more positive pressures, and a curve is developed for use when estimating combustion cylinder 12 pressure during operation. The curve may be linear and with a scaling factor that varies with temperature. For this reason, as shown in FIG. 2, it is also useful to have a temperature sensor 17 in the vicinity of the magnetostrictive sensors. In one example, temperature sensor 17 comprises a thermocouple.

In the embodiment wherein the sensor signal is first sent through amplifier 66, filter 68, and variation detection unit 70, for temperature compensation, if the signal processing elements are situated close enough to the coils 49, an amplifier with a temperature sensitive gain element 76 such as a thermistor is useful. When applying an alternating current field, to avoid noise, the frequency should be well above the fundamental frequency (typically 50 Hz or 60 Hz). In one example, the selected frequency ranges from about 1 KHz to several hundred KHz. In such embodiments, the variation detection unit may be used to remove the 1 KHz component to more clearly observe the variations in this AC signal over the desired measurement bandwidth over time.

In addition to or instead of using temperature for calibration, in another embodiment, multiple magnetostrictive sensors or coils of such sensors are positioned in different orientations. A coil that is oriented in a circumferential direction would be expected to be primarily affected by tensile stress from the combustion chamber, whereas a coil that is oriented in a longitudinal direction would be expected to be primarily affected by compressive stress which has a relatively lower permeability. By obtaining measurements in multiple directions, when evaluating the resulting signals, it can be determined whether noise is affecting the signal, and, if so, the noise can be suppressed. As discussed above with respect to FIG. 4, embodiments with multiple sensors in different directions are also useful when it is difficult to precisely align the sensors as alignment becomes less important with a plurality of sensors

FIG. 6 is another example and illustrates a perspective view of three magnetostrictive sensors 24 coupled to a support plate 32 in accordance with still another embodiment of the disclosure. In this embodiment, each magnetostrictive sensor 24 comprises a core 26 having an excitation winding 28 wound around one arm and a sensing winding 30 wound around the opposite arm. FIG. 6 additionally illustrates three directions of sensing. Use of a ferromagnetic core helps concentrate the magnetic field but is not required. Air cores are also within the scope of the present disclosure. Example ferromagnetic core materials include laminated silicon steel and soft ferrite material.

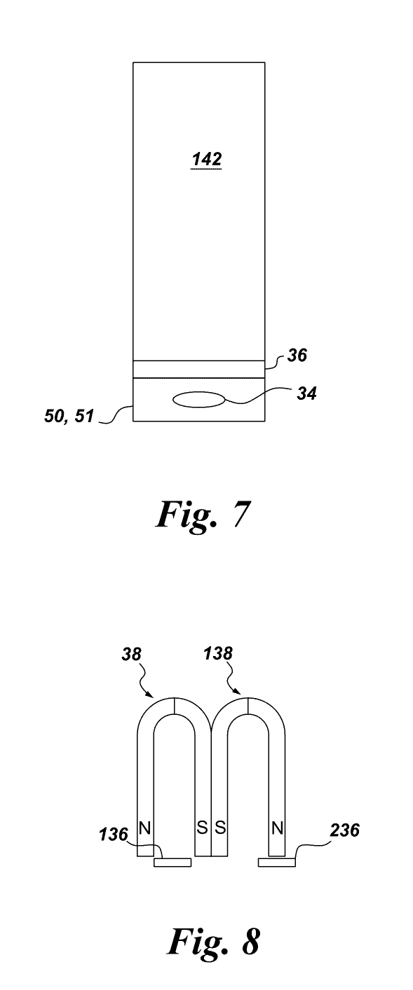

FIGS. 7 and 8 relate to embodiments wherein direct current (DC) magnetostrictive sensors are used to obtain sensor signals representative of pressure within a combustion cylinder. These embodiments are passive in that no excitation signal is required. Instead permanent magnets or permanent magnetized segments are situated either within the combustion chamber wall or cover 51, 50 (FIG. 7) or within a sensor apparatus positioned within the combustion chamber wall or cover (FIG. 8) close enough to provide coupling for the magnetic field to penetrate the surface. As the pressure changes in the combustion cylinder, the DC magnetization changes that the electromagnetic properties sensed by the magnetostrictive sensor will be proportional to the pressure. In these embodiments, magnetic field sensors such as Hall effect or magnetoresist effect sensors may be used.

In the embodiment of FIG. 7 which represents a view of a shaft 142, a magnetostrictive sensor 36, and a portion of a cover or wall 50, 51, the cover or wall comprises a permanent magnet or permanently magnetized segment 34 therein, and magnetostrictive sensor 36 is positioned close enough to sense changes in a magnetic field of the permanent magnet/segment 34. One example method for magnetization is described in Sihler U.S. Pat. No. 7,631,564. For such embodiments, the material of the combustion cylinder must be sufficiently magnetically hard to enable permanent magnetization. One such example is steel alloy 4340. Various steel and other alloys may be hardened based on the chemical composition, grain structure, or combinations thereof. In DC embodiments, the magnetization vector tends to align with an axis and has an alignment angle which changes in response to permeability. As the permeability of combustion cylinder wall 51 or cover 50 changes, the sensor signal from magnetostrictive sensor 36 will change. Processing of the sensor signal may be done in a similar manner as discussed with respect to FIG. 5 except that frequency conversion is not a factor in DC embodiments such that variation detection unit 70 is not applicable.

In the embodiment of FIG. 8, combustion cylinder 12 does not include permanently magnetized sections. Instead, permanent magnet pairs 38, 138 are situated in a shaft (such as shaft 42 of FIG. 3) to be used as magnetic sources. DC magnetostrictive sensors 136, 236 may be positioned in or on the shaft between arms of a magnet pair 38 or 138 as shown by magnetostrictive sensor 136 or in between a leg of the magnet pair and the combustion cylinder 12 (not shown in FIG. 8) as shown by magnetostrictive sensor 236, for example.

When selecting the location of the magnetostrictive sensors in the embodiments wherein a magnetostrictive sensor is positioned relative to combustion chamber wall 51, it is useful to know where the stress concentration is likely to occur in the combustion cylinder and to position the magnetostrictive sensor or sensors near the location of highest expected stress. The base stress of the combustion chamber will depend upon the configuration of the chamber and the location of the fuel and air inlets and may be taken into account when positioning the magnetostrictive sensors.

The above embodiments may be used to provide a robust, cost-effective pressure sensor for engine monitoring and control. Additionally, when a minimally intrusive sensor is used such that the sensor is not inside the high pressure interior of the combustion cylinder, there are further benefits from the sensor element not being placed into the hostile environment of the combustion chamber. Such an embodiment enables use of a sensor having lower temperature requirements, experiencing less thermal and mechanical stress, being exposed to less corrosive gasses, and avoiding potential for leakage of gas from the combustion chamber.

While only certain features of the disclosure have been illustrated and described herein, many modifications and changes will occur to those skilled in the art. It is, therefore, to be understood that the appended claims are intended to cover all such modifications and changes as fall within the true spirit of the disclosure.

1. An engine comprising:
a combustion chamber housing surrounding a combustion chamber;
a magnetostrictive sensor positioned outside of the combustion chamber and configured for obtaining a sensor signal representative of pressure within the combustion chamber; and
a controller for receiving the sensor signal from the sensor, using the sensor signal for estimating the pressure within the combustion chamber, and determining whether to adjust engine operating parameters of the engine in response thereto.

2. The engine of claim 1 further comprising a temperature sensor positioned and configured for obtaining a temperature signal representative of a temperature of the combustion chamber for use in estimating the pressure within the combustion chamber.

3. The engine of claim 1 wherein the combustion chamber comprises a combustion cylinder.

4. The engine of claim 1 wherein the combustion chamber housing comprises at least one combustion chamber wall and a combustion chamber cover, and wherein the magnetostrictive sensor is integrated within the combustion chamber wall or the combustion chamber cover.

5. The engine of claim 4 wherein the combustion chamber cover comprises at least one cavity, and wherein the magnetostrive sensor is positioned within the least one cavity and facing a mechanical load region of the combustion chamber cover.

6. The engine of claim 4 wherein the combustion chamber wall comprises at least one cavity, and wherein the magnetostrive sensor is positioned within the least one cavity and facing a mechanical load region of the combustion chamber wall.

7. The engine of claim 1 wherein the magnetostrictive sensor comprises at least one coil configured for receiving an excitation signal and sensing the sensor signal.

8. The engine of claim 7 wherein the magnetostrictive sensor further comprises a support structure, and wherein the at least one coil comprises a plurality of coils situated on the support structure.

9. The engine of claim 7 wherein the at least one coil comprises an inductive excitation winding for transmitting the excitation signal and an inductive sensing winding for sensing the sensor signal.

10. The engine of claim 1 wherein the magnetostrictive sensor comprises a direct current magnetic field sensor.

11. The engine of claim 10 wherein a wall or a cover of the combustion chamber comprises a permanent magnet or permanently magnetized segment therein and wherein the magnetostrictive sensor is positioned close enough to the permanent magnet or permanently magnetized segment to sense changes in a magnetic field of the permanent magnet or permanently magnetized segment.

12. The engine of claim 10 further comprising a permanent magnet pair positioned close enough to a wall or cover of the combustion chamber to provide coupling for a magnetic field to penetrate the surface of the wall of the combustion chamber, and wherein the magnetostrictive sensor is positioned close enough to a magnetic field-penetrated region of the wall of the combustion chamber for the magnetostrictive sensor to sense changes in magnetic field of the magnetic-field penetrated region.

13. The engine of claim 1 further comprising an amplifier, a filter, and a variation detection circuit for processing the sensor signal.

14. The engine of claim 13 wherein the amplifier includes a temperature sensitive gain element.

15. A combustion cylinder comprising:
a combustion cylinder wall extending along a length of a combustion chamber;
a combustion cylinder cover;
a magnetostrictive sensor positioned within a cavity of the combustion chamber or the combustion cover wall and configured for obtaining a sensor signal representative of pressure within the combustion chamber.

16. The combustion cylinder of claim 15 wherein the magnetostrictive sensor comprises at least one coil configured for receiving an excitation signal and sensing the sensor signal.

17. The combustion cylinder of claim 16 wherein the magnetostrictive sensor further comprises a support structure, and wherein the at least one coil comprises a plurality of coils situated on the support structure.

18. The combustion cylinder of claim 15 wherein the magnetostrictive sensor comprises a direct current magnetic field sensor.
